(19) United States
(12) Patent Application Publication
(10) Pub. No.: US 2019/0283062 A1
(43) Pub. Date: Sep. 19, 2019

(54) APPLICATION DEVICE FOR APPLYING A FLUID PRODUCT WHOSE DOSING FLOW DEPENDS ON THE SPEED OF AN OPENING THROUGH WHICH THE FLUID PRODUCT IS OUTPUT

(71) Applicant: EXEL INDUSTRIES, Epernay (FR)

(72) Inventors: Philippe DE TALHOUET, PARIS (FR); Nicolas FERRERE, PRECY SUR OISE (FR)

(21) Appl. No.: 16/352,289

(22) Filed: Mar. 13, 2019

(30) Foreign Application Priority Data
Mar. 15, 2018 (FR) 1852232

(51) Int. Cl. B05B 12/12; B25J 11/00; B05C 5/00; B05C 11/10

(52) U.S. Cl. CPC B05B 12/126; B05C 11/10; B05C 5/002; B25J 11/0075

(57) ABSTRACT

An application device for applying at least one fluid product on a substrate, including an application member having an outlet orifice for the fluid product(s) outside the application device and, for at least one fluid product, an adjusting member able to adjust a dosing flow of the fluid product through the outlet orifice as a function of a command input of the adjusting member provided by a command module, the application device also including a speed measuring device able to determine a measured speed of the outlet orifice relative to an inertial reference, the command module being configured to determine the command input as a function of the measured speed.

### CROSS-REFERENCE TO RELATED APPLICATION

This application claims priority of French Patent Application No. 18 52232, filed on Mar. 15, 2018.

### FIELD OF THE INVENTION

The present invention relates to an application device for applying at least one fluid product on a substrate, the application device being of the type including:
an application member, for shaping the or each fluid product for its application on the substrate, the application member having an outlet orifice for the fluid product(s) outside the application device,
for at least one fluid product, an adjusting member able to adjust a dosing flow of the fluid product through the outlet orifice as a function of a command input of the adjusting member, and
a command module for determining the command input and supplying it to the adjusting member.

“Fluid product” here and hereinafter refers to a product having a viscosity of between 1 mPa·s and 2 kPa·s, this viscosity, for example, being measured using a Brookfield Plan Cone viscosimeter under normal temperature and pressure conditions. This expression thus encompasses products in liquid state, perfectly deformable and with a low viscosity, as well as products generally described as “pasty”, more viscous than liquids and having a state midway between the liquid state and the solid state.

The invention also relates to an applicator robot including such an application device, and a method for applying a fluid product on a substrate using such an application device.

### BACKGROUND OF THE INVENTION

Application devices of the aforementioned type are known. They are generally used to apply, on surfaces, fluid products such as lines of glue or paint, in particular when precise control of the flow of fluid product leaving the application device is required. To that end, these application devices are mounted on robotic articulated arms controlled by control bays so as to move the application members of the application devices relative to the surfaces to be covered. These control bays are most often arranged next to the articulated arms, and each application device has its own control cabinet arranged next to the control bay of the articulated arm on which the application device is mounted.

Generally, the aim sought with the use of this type of application device is to distribute the fluid product as homogeneously as possible on the surface to be covered.

This aim is easily achievable when the speed of the outlet orifice, also called “tool tip speed”, is constant: in order to obtain a homogeneous distribution of the fluid product over the surface to be covered, it indeed suffices in this case to maintain a substantially constant dosing flow, which one knows how to do without difficulty.

A complication occurs, however, when the tool tip speed varies, for example when the movement direction of the application member changes after the arrival of the application member at the end of the surface to be covered. In this case, the dosing flow must be modified in proportion to the tool tip speed so as to continue locally to apply a constant quantity of product; in particular, the dosing flow must be decreased when the movement of the outlet orifice slows down and increased when the movement of the outlet orifice speeds up.

In order for the dosing flow thus to be able to be adjusted based on the tool tip speed, this tool tip speed must be known by the control module. To that end, robotic arms have been developed suitable for communicating, to the control cabinets of the application devices mounted above, an estimate of the tool tip speed based on the movement instructions communicated by the control bay to the articulated arm. The solution is, however, unsatisfactory on several points:
it poses compatibility problems between the robotic arms and the application devices,
it does not allow the adjustment of the dosing flow as a function of the tool tip speed when the application device is mounted on an older generation robotic arm not having the aforementioned function, and
the delay induced by the processing of the speed information at the control cabinet of the application device, then the transmission of the command input to the adjusting member generally causes a delay in the correction of the dosing flow that makes this correction unsuitable.

### SUMMARY OF THE INVENTION

One aim of the invention is thus to allow the homogeneous application of a fluid product on a surface to be covered, irrespective of the movement speed of the outlet orifice of the fluid product relative to the surface and irrespective of the device used to move the outlet orifice.

To that end, the invention relates to an application device of the aforementioned type, wherein the application device also includes a speed measuring device able to determine a measured speed of the outlet orifice relative to an inertial reference, and the command module is configured to determine the command input as a function of the measured speed.

According to specific embodiments of the invention, the application device also has one or more of the following features, considered alone or according to any technically possible combination(s):
the command input is suitable so that the ratio between the dosing flow of the fluid product and the measured speed of the outlet orifice is substantially constant,
the speed measuring device includes at least one accelerometer,
the speed measuring device includes at least one gyroscope,
the speed measuring device includes a magnetometer,
the speed measuring device is at a distance from the outlet orifice of less than 15 cm,
the command module is at a distance from the speed measuring device of less than 5 cm,
the command module is at a distance from the adjusting device of less than 10 cm,
the adjusting member is at a distance from the outlet orifice of less than 15 cm; and
the fluid product has a viscosity of between 3000 and 300,000 mPa·s.

The invention also relates to an applicator robot for the application of a fluid product on a substrate, the robot including a frame, an articulated arm forming a plurality of segments articulated relative to one another, a wrist mounted at one end of the articulated arm, and an application device as defined above, the application member of which is mounted at a distal end of the wrist.

According to specific embodiments of the invention, the application device also has one or more of the following features, considered alone or according to any technically possible combination(s):
the command module is mounted on the wrist or on the segment closest to the wrist,
the speed measuring device is mounted on the application member; and
the measured speed is comprised of the speed of the outlet orifice relative to the frame.

The invention also relates to a method for applying a fluid product on a substrate, including the following successive steps:
providing an application device as described above,
dosing the fluid product through the outlet orifice at a first dosing flow, the outlet orifice moving at a first speed,
changing the speed of the outlet orifice, and
   dosing the fluid product through the outlet orifice at a second dosing flow different from the first dosing flow.

### BRIEF DESCRIPTION OF THE DRAWINGS

Other features, details and advantages of the invention will emerge more clearly from the detailed description provided below, for information and in reference to the drawings, in which:

FIG. 1 is a perspective view of an installation for application of a fluid product on a substrate comprising an applicator robot, in accordance with an embodiment of the subject invention;

FIG. 2 is a schematic view of an application device of the applicator robot of FIG. 1, in accordance with an embodiment of the subject invention; and

FIGS. 3 and 4 are block diagrams illustrating a method implemented by the application installation of FIG. 1, in accordance with an embodiment of the subject invention.

### DETAILED DESCRIPTION OF THE INVENTION

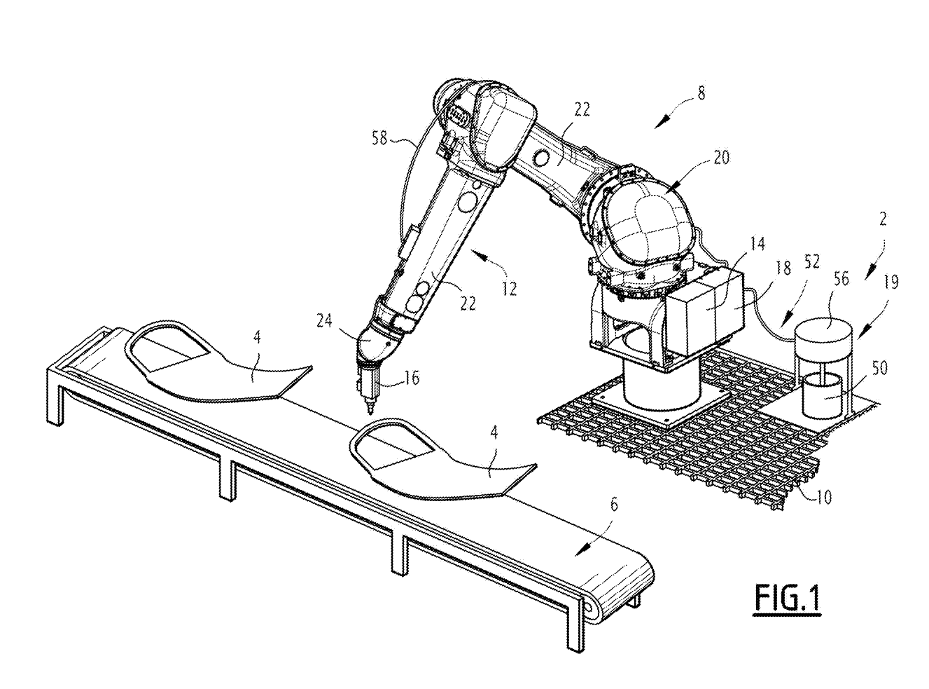

The installation 2 shown in FIG. 1 is intended for the application of a fluid product on substrates 4.

The fluid product is typically made up of a product with a high viscosity; i.e., the viscosity of which is greater than 3000 mPa·s. Examples of such high-viscosity products are typically putties or elastomer or epoxy glues. Advantageously, the fluid product has a viscosity of between 3000 and 30,000 Pa·s.

The substrates 4 here are made up of preformed plates, typically by stamped sheet metal plates.

To that end, the installation 2 includes, in a known manner, a system 6 for moving substrates 4 and an applicator robot 8 for the application of the fluid product on the substrates 4.

The movement system 6 is configured to move the substrates 4 inside the installation 2 by immobilizing each substrate 4 relative to the floor 10 of the installation 2, during a predetermined duration, within an action perimeter of the applicator robot 8.

In the illustrated example, the movement system 6 is made up of a conveyor belt bearing the substrates 4.

The applicator robot 8 includes a multiaxial robot 12, a control bay 14 for commanding the robot 12, an application device 16 for the application of the fluid product on the substrates 4, a command cabinet 18 for commanding the application device 12, and a supply system 19 for supplying the application device 16 with the fluid product.

The multiaxial robot 12 includes, in a known manner, a fixed frame (not shown) relative to the floor 10, an articulated arm 20 made up of a plurality of segments 22 articulated relative to one another, and a wrist 24 mounted at one end of the articulated arm 20.

The wrist 24 includes a proximal end (not shown) by which it is connected to one of the segments 22 of the arm 20, and a distal end (not shown) opposite the proximal end.

The multiaxial robot 12 also includes a plurality of motors (not shown), mounted at the interface between the segments 22 of the arm 20 and with the wrist 24, to drive the rotation of the segments 22 and the wrist 24 relative to one another.

The control bay 14 includes electrical circuits (not shown) for determining a command input of each motor of the robot 12 and providing this command input to each affected motor.

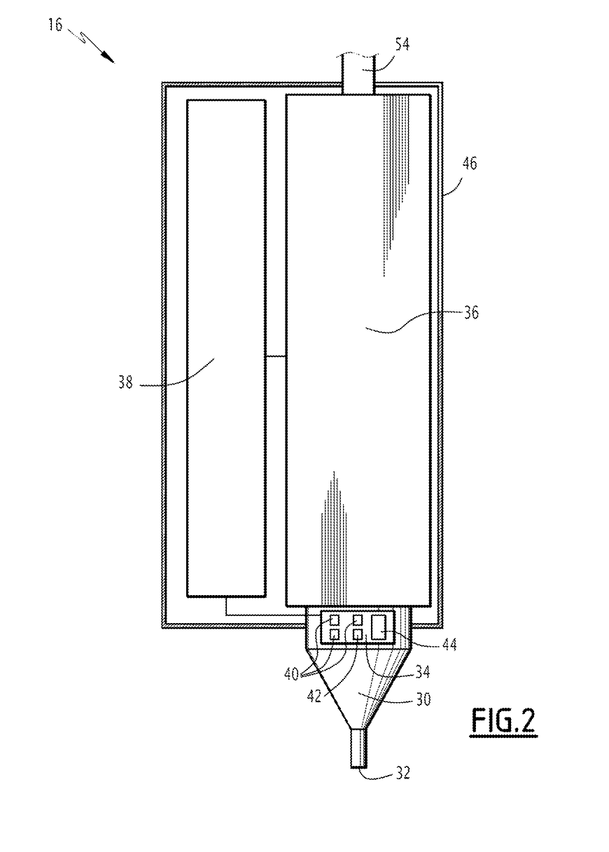

In reference to FIG. 2, the application device 16 includes an application member 30 intended to shape the fluid product for its application on the substrate. To that end, the application member 30 includes an outlet orifice 32 for the exit of the fluid product outside the application device 16, this outlet orifice 32 typically being made up of a nozzle.

The application device 16 also includes a speed measuring device 34, an adjusting member 36 able to adjust a dosing flow of the fluid product through the outlet orifice 32, and a command module 38 for determining a flow command input of the adjusting member 36 and providing the command input to the adjusting member 36.

The speed measuring device 34 is able to determine a measured speed of the outlet orifice 32 relative to an inertial reference, in particular relative to the floor 10 of the installation 2. To that end, the speed measuring device 34 is typically comprised of an inertial unit comprising:
three accelerometers 40, each able to measure an acceleration in a specific direction orthogonal to the acceleration measuring direction of each other accelerometer 40,
a gyroscope 42, able to measure an angular speed around each of three rotation axes orthogonal to one another, and
a magnetometer 44 able to measure the three components of a magnetic field at the magnetometer 44.

Each accelerometer 40 and each gyroscope 42 is typically comprised of an inertial electromechanical microsystem.

The accelerometers 40, the gyroscope 42 and the magnetometer 44 are typically integrated into a shared electronic board (not shown).

The entire speed measuring device 34 is at a distance from the outlet orifice 32 of less than 15 cm. Thus, the movements measured by the speed measuring device 34 are very close to the movements of the outlet orifice 32.

To that end, the speed measuring device 34 is, as shown, mounted on the application member 30.

The speed measuring device 34 is configured to transmit the measured speed to the command module 38.

The adjusting member 36 is able to define the dosing flow of the fluid product through the outlet orifice 32, the dosing flow depending on the flow command input supplied by the command module 38. To that end, the adjusting member 36 is typically made up of a pump supplying the application member 30, the flow of the fluid product leaving the pump making up the dosing flow.

For example, the adjusting member 36 is made up of a single- or double-acting pump including a chamber and a piston (not shown), the movement speed of the piston in the chamber determining the dosing flow. Alternatively, the adjusting member 36 is made up of a pump with axial pistons, the rotation speed of which determines the dosing flow.

The adjusting member 36 is at a distance from the outlet orifice 32 of less than 15 cm. Thus, the variations of the outlet flow of the pump are passed on almost instantaneously to the dosing flow.

The command module 38 is configured to determine the flow command input as a function of the measured speed, and to adapt the input such that the ratio between the dosing flow of the fluid product and the measured speed of the outlet orifice 32 are substantially constant.

To that end, the command module 38 is adapted to receive the measured speed from the measuring device 34, and to deduce the flow command input from the measured speed. To that end, the command module 38 is typically made in the form of programmable logic components and/or dedicated integrated circuits included in the application device 16.

The entire command module 38 is at a distance from the speed measuring device 34 of less than 5 cm and at a distance from the adjusting member 36 of less than 10 cm. Thus, the information exchanges between the command module 38 and each of the speed measuring device 34 and adjusting member 36 are practically instantaneous, which allows very high reactivity of the adjusting member 36 following the speed variations of the outlet orifice determined by the measuring device 34.

In the illustrated example, the application member 30, the speed measuring device 34, the adjusting member 36 and the command module 38 are all integrated into a same unit 46 mounted on the wrist 24 of the articulated arm 20. Alternatively, at least part of the application device 16 is not mounted on the wrist 24; for example, the adjusting member 36 is mounted on the segment 22 of the articulated arm 20 closest to the wrist 24.

Irrespective of the mounting of the application device 16, the application member 30 is preferably always mounted at the distal end of the wrist 24.

Returning to FIG. 1, the supply system 19 includes a vat 50 containing the fluid product, and a fluid transfer system 52 for transferring the fluid product contained in the vat 50 to an inlet 54 (FIG. 2) of the adjusting member 36.

The fluid transfer system 52 is suitable for supplying the fluid product to the application device 16 at a pressure greater than 1.1 times the atmospheric pressure. To that end, the fluid transfer system 52 includes an elevating group 56 for pumping the fluid product into the vat 50, and a pipe 58 fluidly connecting an outlet (not shown) of the elevating group 56 to the inlet 54 of the adjusting member 36.

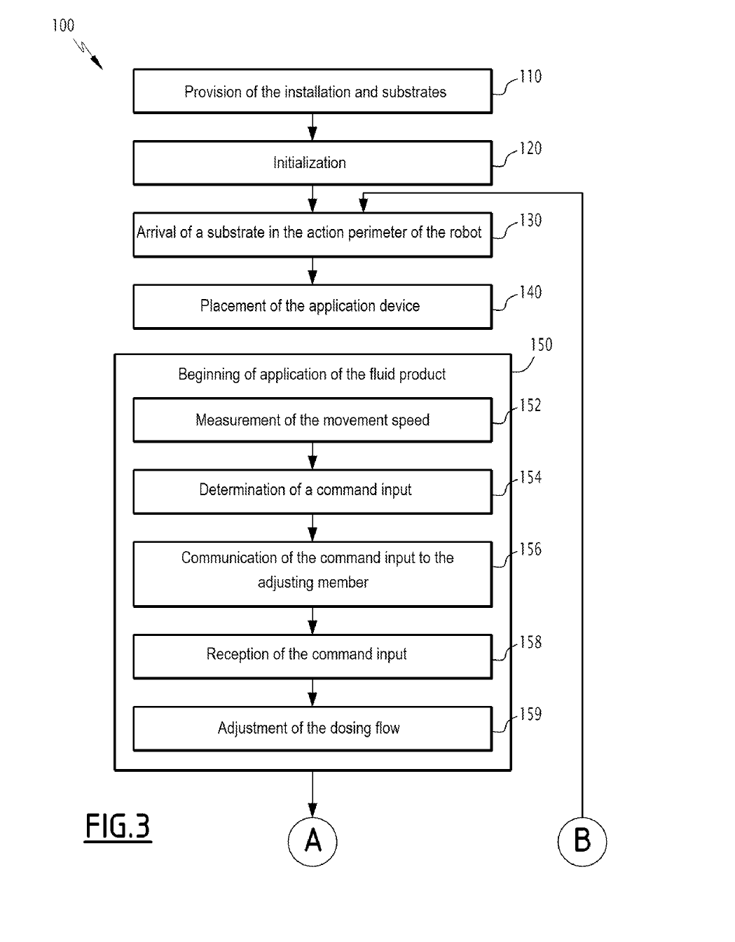

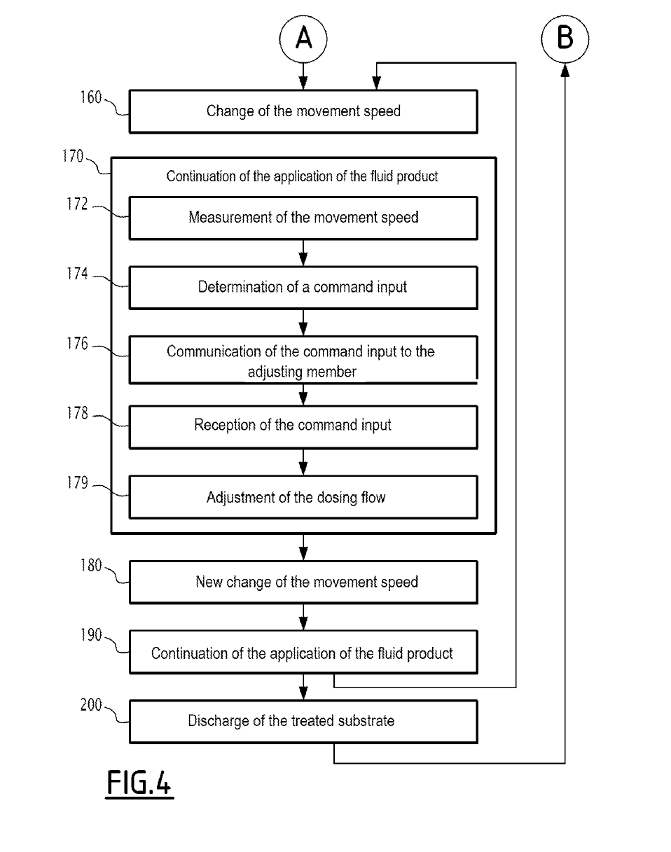

An application method 100 of the fluid product using the installation 2 will now be described in reference to FIG. 3.

First of all, during a first step 110, the installation 2 and the substrates 4 are provided.

This step 110 is followed by an initialization step 120.

This step 120 includes a first sub-step during which the elevating group 56 is activated. The latter then begins to pump the product into the vat 50 and discharge it into the pipe 58.

Step 120 also includes a second sub-step, substantially simultaneous with the first sub-step, during which the measuring device 34 is activated. As of this sub-step, the measuring device 34 continuously measures the speed of the outlet orifice 32.

Next, during a step 130, a substrate 4 is contributed by the movement system 6 in the action perimeter of the applicator robot 8, then immobilized in the action perimeter.

The control bay 14 then commands, during a step 140, the movement of the articulated arm 20 so as to place the outlet orifice 32 of the application device 16 opposite a surface to be covered of the substrate 4, at a suitable distance for the application of the fluid product on the surface.

Then, during a step 150, the applicator robot 8 begins the application of the fluid product on the substrate 4.

All throughout this step 150, the outlet orifice 32 is moved by the robot 12, relative to the floor 10, at a first speed, following the surface to be covered, and an input is communicated by the command cabinet 18 to the application device 16 for the application of the fluid product.

Step 150 includes a first sub-step 152 during which the first speed is measured by the measuring device 34.

Next, during a sub-step 154, the command module 38 determines a first command input of the adjusting member 36 as a function of the first speed and communicates the first command input to the adjusting member 36 during a sub-step 156.

This command input is received by the adjusting member 36 during a sub-step 158, after which the adjusting member 36 adjusts the dosing flow to a first flow during a sub-step 159. This first flow is such that the ratio of the first flow to the first speed is equal to a predetermined constant.

The fluid product is next applied with a dosing flow equal to the first flow during the entire remainder of step 150.

Then, during a step 160, the robot 12 modifies the movement speed of the outlet orifice 32 relative to the floor 10. This change of speed typically consists of a slowing occurring during a change in the movement direction of the outlet orifice 32.

Step 160 is thus followed by a step 170 for continuing the application of the fluid product on the substrate 4 at a modified speed.

All throughout this step 170, the outlet orifice 32 is moved by the robot 12, relative to the floor 10, at the modified speed, following the surface to be covered, and an input is communicated by the command cabinet 18 to the application device 16 for the application of the fluid product.

Step 170 includes a first sub-step 172 during which the modified speed is measured by the measuring device 34.

Next, during a sub-step 174, the command module 38 determines a new command input of the adjusting member 36 as a function of the modified speed and communicates the new command input to the adjusting member 36 during a sub-step 176.

This new command input is received by the adjusting member 36 during a sub-step 178, after which the adjusting member 36 adjusts, during a sub-step 179, the dosing flow to a new flow. This new flow is such that the ratio of the new flow to the modified speed is equal to the predetermined constant.

The fluid product is next applied with a dosing flow equal to the new flow during the entire remainder of step 170. This results in an application of the fluid product that is homogeneous with the application previously done.

Then, during a step 180, the robot 12 again modifies the movement speed of the outlet orifice 32. This change of speed typically consists of an acceleration following the change in the movement direction of the outlet orifice 32 having occurred during steps 160 and 170.

Step 180 is thus followed by a new step 190 for continuing the application of the fluid product on the substrate 4 at a modified speed. This step 190 is identical to step 170.

Steps 160, 170, 180 and 190 are repeated upon each change of the movement direction of the outlet orifice 32.

Lastly, once the entire surface to be covered is covered with the fluid product, the substrate 4 is discharged by the movement system 6 outside the action perimeter of the applicator robot 8 during a step 200.

Steps 130 to 200 are next repeated until all of the substrates 4 have been treated by the applicator robot 8.

Owing to the invention described above, it is thus possible to apply a fluid product on a surface to be covered homogeneously, independently of the movement speed of the outlet orifice of the fluid product relative to the surface and independently of the means used to move the outlet orifice.

This solution is thus versatile. It is further economical, since it allows the reuse of multiaxial robots not equipped with a module for communicating the estimated tool tip speed.

In the example described above, the applicator robot 8 is suitable for the application of a single fluid product at a time. Alternatively (not shown), the applicator robot 8 is suitable for the application of several fluid products at once. In this case, the applicator robot 8 includes, aside from the supply system 19, at least one other supply system, one per fluid product, to supply the application device 16 with each of the fluid products. Furthermore, the application device 16 then includes an adjusting member 36 for each fluid product, the command module 38 being configured to produce, for each of the adjusting members, a command input as a function of the speed measured by the speed measuring device 34.

1. An application device for applying at least one fluid product on a substrate, the application device comprising:
an application member, for shaping the or each fluid product for its application on the substrate, the application member comprising an outlet orifice through which the fluid product(s) come out of the application device;
for at least one fluid product, an adjusting member able to adjust a dosing flow of the fluid product through said outlet orifice as a function of a command input of the adjusting member;
a command module for determining the command input and supplying it to said adjusting member; and
a speed measuring device able to determine a measured speed of said outlet orifice relative to an inertial reference, wherein said command module is configured to determine the command input as a function of the measured speed.

2. The application device according to claim 1, wherein the command input is suitable so that the ratio between the dosing flow of the fluid product and the measured speed of said outlet orifice is substantially constant.

3. The application device according to claim 1, wherein said speed measuring device comprises at least one accelerometer.

4. The application device according to claim 1, wherein said speed measuring device comprises at least one gyroscope.

5. The application device according to claim 1, wherein said speed measuring device comprises a magnetometer.

6. The application device according to claim 1, wherein said speed measuring device is at a distance from said outlet orifice of less than 15 cm.

7. The application device according to claim 1, wherein said command module is at a distance from said speed measuring device of less than 5 cm.

8. The application device according to claim 1, wherein said command module is at a distance from said adjusting member of less than 10 cm.

9. The application device according to claim 1, wherein said adjusting member is at a distance from said outlet orifice of less than 15 cm.

10. The application device according to claim 1, wherein the fluid product has a viscosity of between 3,000 and 300,000 mPa·s.

11. An applicator robot for the application of a fluid product on a substrate, the applicator robot comprising:
a frame;
an articulated arm having a plurality of segments articulated relative to one another;
a wrist mounted at one end of said articulated arm; and
the application device according to claim 1, the application member of which is mounted at a distal end of said wrist.

12. The applicator robot according to claim 11, wherein the command module is mounted on said wrist or on the segment closest to said wrist.

13. The applicator robot according to claim 11, wherein the speed measuring device is mounted on the application member.

14. The applicator robot according to claim 11, wherein the measured speed comprises the speed of the outlet orifice relative to the frame.

15. A method for applying a fluid product on a substrate, comprising:
providing an application device according to claim 1,
dosing the fluid product through the outlet orifice at a first dosing flow, the outlet orifice moving at a first speed,
changing the speed of the outlet orifice, and
dosing the fluid product through the outlet orifice at a second dosing flow different from the first dosing flow.
